(19) United States
(12) Patent Application Publication
(10) Pub. No.: US 2009/0292792 A1
(43) Pub. Date: Nov. 26, 2009

(54) MANAGEMENT INFON, METHOD AND SYSTEM FOR WORKFLOW MANAGEMENT IN A COMMUNICATIONS NETWORK

(75) Inventors: Said Soulhi, Montreal (CA); Claes Goran Robert Edstrom, Beaconsfield (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/124,718

(22) Filed: May 21, 2008

(51) Int. Cl. G06F 15/173

(52) U.S. Cl. 709/220

(57) ABSTRACT

The invention relates to a computer readable medium containing a management infon modeling an execution result of a management activity in a communications network. The management infon comprises a descriptor of the management activity, at least one value representing a managed object involved in the management activity and an indication of the execution result of the management activity. The invention further relates to a method for workflow management in a communications network comprising the steps of executing a management activity defined by at least one workflow, creating a management infon modeling an execution result of the management activity and managing said at least one workflow using said management infon. The invention also relates to a computer system in a communications network comprising a processor for executing a function creating a management infon modeling an execution result of a management activity.

### FIELD OF THE INVENTION

The present invention relates to a management infon, and more particularly to a management infon for workflow management in a communications network.

### BACKGROUND OF THE INVENTION

Network management systems have previously been designed to handle a limited number of nodes and technologies and are therefore not suited to handle end-to-end (e2e) services covering multiple network types and multiple technologies. With current developments and standardizations, the Next Generation Network (NGN) network management systems are moving towards handling multiple technologies and multiple networks.

With these developments, the requirements for a NGN network management system also include streamlined procedures that are highly automated with little manual intervention. The increasing complexity of the network components and the need to increase the abstraction level emphasizes the importance of workflow management.

Workflows represent the automation of procedures where information or tasks are passed between participants according to a predefined set of rules to achieve, or contribute, to an overall business goal.

The Workflow Management Coalition (WfMC) is a consortium formed to define standards to enable interoperability between workflow management systems. It was founded in 1993 and its Workflow Reference Model was first published in 1995. The WfMC also developed an XML Process Definition Language (XPDL) which is an Extensible Markup Language (XML) based language, for describing a process definition. The version 1.0 of this language was published in 2002 and the version 2.0 was published in 2005.

The definition of a workflow as specified by WfMC is: “The computerized facilitation or automation of a business process, in whole or part” and the definition of a workflow management system as specified by WfMC is: “System that completely defines, manages and executes “workflows” through the execution of software whose order of execution is driven by a computer representation of the workflow logic”.

As described above, the NGN networks consist of variety of network types, node types, platforms and technologies all of which needing to be managed e2e by a homogenous management system.

There is, in this context, and from a workflow point of view, fast growing management requirements to support increased streamlined procedures and highly automated procedures across network domains, new and fast growing end user services and increased management abstraction level. There are also shortcomings with current workflow system solutions existing today where there is no formal data interchange framework for heterogeneous workflows, no formal interoperability between heterogeneous workflows, no common look and feel between heterogeneous workflows, no formal way to track the execution of the workflow logic and no formal background to workflow management.

These problems, are outlined by the WfMC. According to the WfMC, regarding process and activity state transitions: “The potential treatment of interruptible activities and atomic activity units with restart capability will require further consideration and is beyond the initial work of the Coalition” and “This section covers the general principles of data interchange; this area will require further specification work”.

Still according to the WfMC, “Where interworking between heterogeneous workflow products is planned they must either follow the same approach to application data interchange or interwork through a gateway mechanism, which can map between the two approaches and/or handle any differences in object naming and data type conventions by appropriate conversion. Further work is required on the details in this area, but it is possible that alternative interchange conformance criteria could be identified to cover the two cases.”

Still according to the WfMC, regarding workflow interoperability, “In this area it is expected that relatively simple interoperability scenarios will be supported initially, with the more complex situations requiring further work on interoperability definitions.” and “Although it is possible to consider the development of very complex interoperability scenarios in which a number of different vendor engines cooperate to deliver a single enactment service, this scenario is unlikely to be realized in the near future as it requires that all engines can interpret a common process definition and share a common set of workflow control data, in effect maintaining a shared view of process states across the heterogeneous workflow control engines.”

The Telecommunications and Internet Converged Services and Protocols for Advanced Networks (TISPAN) architecture known from the prior art defines interfaces between process managers and supporting business process managers. This, however, does not include mechanisms for interchange of workflow data between the underlying workflows, nor interaction between workflows. This conclusion is also true for the TeleManagement Forum (TMF) Next Generation Operations Support Systems (NGOSS) architecture.

The Patent application publication US 20020040396 generally relates to the field of the present invention. This publication describes how to evaluate the impact of a policy on a specific managed device and how to react to the evaluation with a dynamic adjustment.

Furthermore, patent applications publications US 20050256947, US 20070124797 and U.S. Pat. No. 6,988,133 also bear some relation with the field of the present invention. These documents describe, respectively, dynamic parameterized policies, a life-cycle approach to policy management and how to test a set or policies before their activation.

Therefore it would be desirable to provide systems and methods for workflow management in a multiple systems and multiple vendors communication network.

### SUMMARY

According to a first aspect of the invention, a computer readable medium containing a management infon modeling an execution result of a management activity in a communications network is provided. The management infon comprises a descriptor of the management activity, at least one value representing a managed object involved in the management activity and an indication of the execution result of the management activity.

According to another aspect of the invention, a method for workflow management in a communications network is provided. The method comprises the steps of executing a management activity defined by at least one workflow, creating a management infon modeling an execution result of the management activity and managing the at least one workflow using the management infon.

According to another aspect of the invention, a method for workflow management in a communications network is provided. The method comprises the steps of creating a main management situation, MS, for containing at least one management infon, creating at least two secondary management situation, MS1 and MS2, being associated with respective workflows, each containing at least one management activity, executing the at least one management activity of each of the respective workflows, creating the management infon modeling an execution result of each of the at least one management activity, storing the management infon in the MS1 and the MS2 respectively and joining the MS1 and the MS2 in the MS.

According to yet another aspect of the invention, a computer system in a communications network is provided, the computer system comprising a processor for executing a function creating a management infon modeling an execution result of a management activity.

### BRIEF DESCRIPTION OF THE DRAWINGS

The objects and advantages of the invention will be understood by reading the following detailed description in conjunction with the drawings.

FIG. 1 is an exemplary block diagram showing a management infon according to an embodiment of the invention.

FIG. 2 is an exemplary block diagram showing nodes and their components according to an embodiment of the invention.

FIG. 3 is an exemplary flowchart illustrating the steps of a method according to an embodiment of the invention.

FIG. 4 is an exemplary flowchart illustrating the steps of another method according to an embodiment of the invention.

FIG. 5 is an exemplary block diagram showing chained workflows and a corresponding management situation.

FIG. 6 is an exemplary block diagram showing hierarchical workflows and a corresponding management situation.

FIG. 7 is an exemplary block diagram showing a meshed workflow and a corresponding management situation.

FIG. 8 is an exemplary block diagram illustrating the Workflow Management Coalition (WfMC) reference model modified according to the present invention.

### DETAILED DESCRIPTION

The various features of the invention will now be described with reference to the figures. These various aspects are described hereafter in greater detail in connection with an exemplary embodiment and examples to facilitate an understanding of the invention, but should not be construed as limited to this embodiment. Rather, this embodiment is provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that the various actions could be performed by specialized circuits (e.g., discrete logic gates interconnected to perform a specialized function), by program instructions being executed by one or more processors, or by a combination of both. Moreover, the invention can additionally be considered to be embodied within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

The embodiment according to the present invention is described with reference to block diagrams and/or operational illustrations of methods, servers, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, Application-Specific Integrated Circuit (ASIC), and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed.

The present invention introduces new workflow situation semantics concepts. These concepts are the management infons for network management activities, which are preferably stored in at least one management situation for at least one workflow and operations on management situations for the management of workflows.

A management infon is a data structure inspired from the infon of the situation semantics theory, which is a general theory of information content considered as the foundation of many modern approaches in information theory and cognitive science. Its development into a formal mathematical model of information flow through complex systems is explained in: Jon Barwise, Jerry Seligman, Information Flow, The Logic of Distributed Systems, Journal of Logic, Language and Information Volume 8, Number 3/July, 1999. Central to this model is the notion of an information channel, capable of preserving information as it is transmitted through a complex, causally interacting system. The basic ontology includes:
relations, denoted by P, Q, R;
objects, denoted by a, b, c;
spatial locations, denoted by l, l′, l″;
temporal locations, denoted by t, t′, t″;
situations, denoted by s, s′, s″; and
polarity: denoted by p and equal to 1 (true) or 0 (false).

The management infon of the present invention has been devised for modeling a management activity. It is a state-of-affair corresponding to an activity instance. It states if a network management activity instance has been executed successfully or not and makes a specific relation between certain managed objects. The generic syntax chosen for a management infon for a network management activity is provided by (1).

<<R, al, . . . , an, l, t, p>> (1)

In (1), the relation “R” models the activity, the objects “al, . . . , an” model managed objects involved in the activity, the spatial location “l” represents the location of execution of the activity and the temporal location “t” represents the time of execution of the activity. The polarity “p” captures that fact that a task has been completed and executed successfully or not.

The management infon, as used in the exemplary embodiments described below is a computationally viable unit of semantic information content i.e. a mathematical object used in situation semantics.

Still according to the situation semantics theory, a simple infon can convey that certain objects stand in some relation or, alternatively, do not stand in that relation.

The management situation of the present invention has been inspired from the situation of the situation semantics theory, in which the situation is another unit of information which is defined as a set or a chain of infons. A characteristic of the situation semantics theory is that the meaning or semantics is contextual, i.e., the meaning of an infon depends on a situation. The following proposition indicates that s supports φ:

s|=φ (2)

This means that “s” is the real situation that makes the infon “φ” factual. In the context of the situation semantic theory or semantic methods or models for processing information, information relates to a situation, i.e., the context of the data. Situations are partial, in contrast with possible worlds which are total. This means that they capture a part only of a given reality or of a scene involving some individuals, relations, locations and times.

The objects of the situation semantic theory can be used thereby allowing the building of complex entities. Furthermore, from a computational perspective, the situation semantics provides an informational approach to formal semantics where soundness and completeness are mathematically proven, see, e.g., Juan Barba Escriba, “Two Formal Systems for Situation Semantics”, Notre Dame Journal of Formal Logic, Vol. 33 Number 1, 1992.

The exemplary embodiment and the examples provided herein show how the situation semantic theory has been modified and adapted to the management and processing of information outside of the context of linguistics. An exemplary embodiment will first be described with respect to the management and processing of information associated with communication networks, e.g., workflow management. However it will be appreciated that the present invention is not limited thereto.

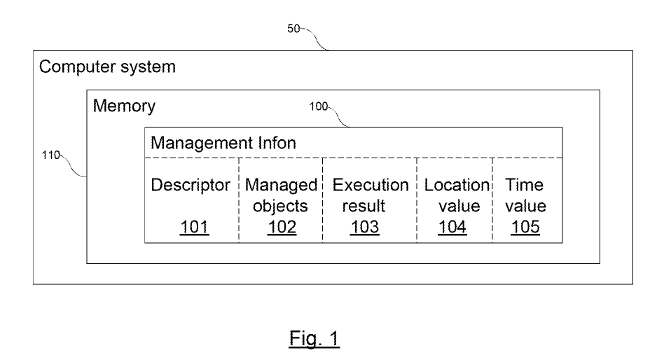

FIG. 1 illustrates a computer readable medium 110 containing a management infon 100 modeling an execution result of a management activity in a communications network. The management infon 100 comprises a descriptor 101 of the management activity. It comprises at least one value representing a managed object 102 involved in the management activity. It also comprises an indication of the execution result 103 of the management activity, which could take many forms such as true/false, yes/no, 0/1, or the like, as apparent to a person skilled in the art.

The management infon 100 may further comprise a location value 104, indicating a location of execution of the management activity and a time value 105, indicating a time of execution of the management activity. The management infon 100 can also be characterized as a mathematical object containing semantic information.

Preferably, the descriptor “R”, of the management activity is a relation modeling the management activity while the indication of the execution result “p” of the management activity is a boolean or truth value indicative of a the execution result or status of the management activity.

Preferably, a management activity can be a control process instance, a transport services handling process, an authentication process, an authorization process, a subscription activation process, an e2e bandwidth management process or any other management process, as would be apparent to a person skilled in the art.

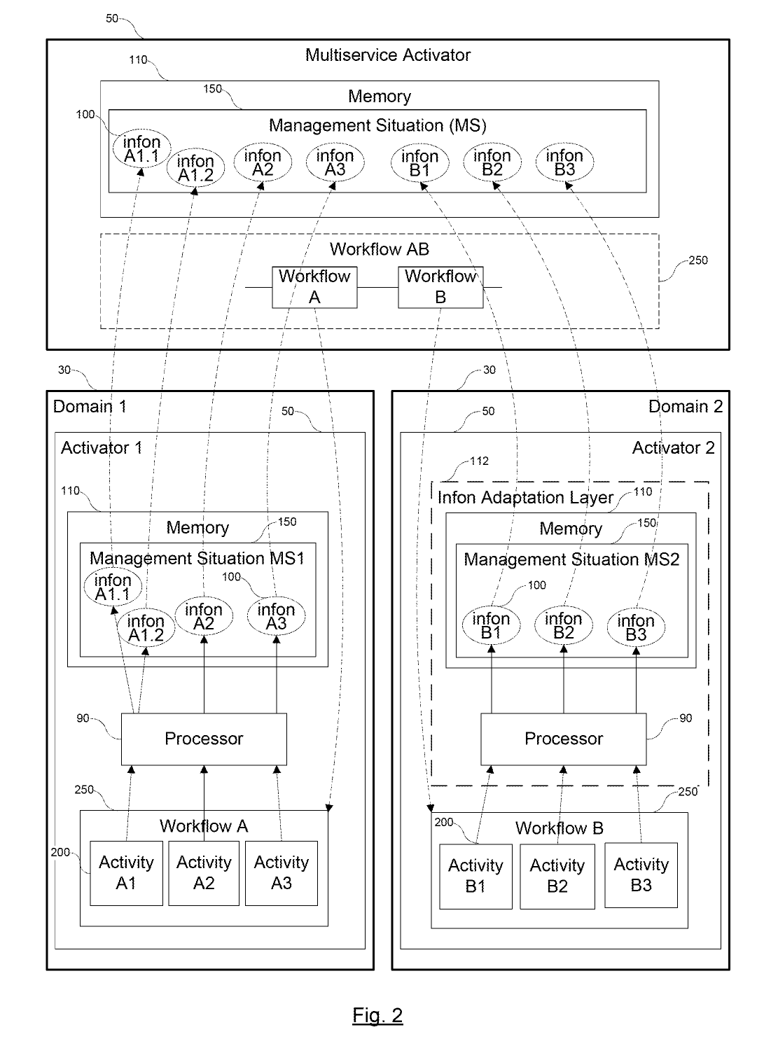

FIG. 2 further illustrates a computer system 50 in a communications network, comprising a processor 90 executing a function creating a management infon 100 and modeling an execution result of a management activity 200. The management infon 100, as described before, comprises a descriptor 101 of the management activity, at least one value representing a managed object 102 involved in the management activity and an indication of the execution result 103 of the management activity. It will be apparent to a person of ordinary skills in the art that the computer system 50 may encompass many types of enablement. For example, the computer system might have been designed with a software function or with hardware supporting the creation and processing of management infons. Alternatively, the computer system could be modified to include an infon adaptation layer 112, in the form of software or hardware, for the creation and the processing of management infons. Furthermore, the computer system 50 could also access functions for the creation and the processing of infons, the functions being executed in another node.

Preferably, the computer system 50 comprises a memory 110 for storing the management infons 100. The management infons 100 are preferably stored in the memory 110 in a management situation 150, MS. Alternatively, the computer system 50 can comprise a function for storing the management infon in a memory 110 located in an other node 50. The memory 110 of the other node 50 can also comprise a management situation 150, MS, for storing the management infons 100.

The invention is also directed to methods for managing multiple workflows controlling the setup and configuration of network resources in a large communication network. These methods preferably are based on applying the situation semantics theory in the area of workflow management, to enable seamless management data interchange handling, using multiple heterogeneous workflow management systems in the context of multiple technologies and multiple vendors networks for Next Generation Networks Operations Support Systems (NGN OSS).

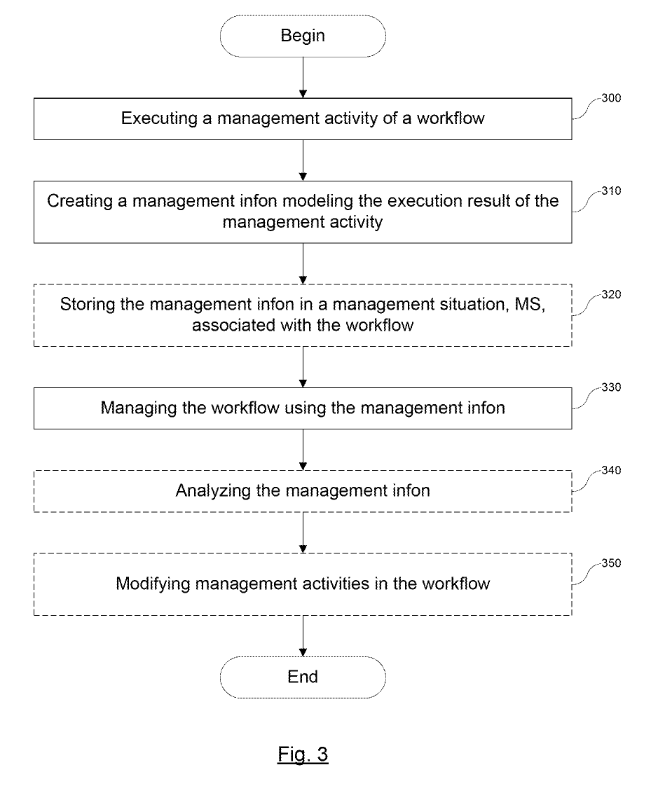

FIG. 3 illustrates the steps of a method for workflow management in a communications network. The method comprises the steps of executing 300 a management activity defined by at least one workflow, creating 310 a management infon modeling an execution result of the management activity and managing 330 the workflows using the management infon. It should be noted that the invention is devised to encompass managing a single workflow as well as multiple workflows.

Preferably, the method is applied to more than one management activity and to more than one management infon. The management infons are preferably stored 320 in a management situation, MS, associated with the workflows 250, shown in FIG. 2. Furthermore, the step of managing preferably comprises analyzing 340 the management infon and modifying 350 management activities in the workflows according to the step of analyzing. As a person skilled in the art would understand, the step of analyzing may comprise, for example, identifying management activities which have succeeded or which have failed and determining further management activities which could be executed in order to complete the execution of a workflow properly. The step of analyzing could also encompass an automation of tasks performed by a person analyzing the result of management activities of a workflow. A person of ordinary skills in the art would further understand that the step of analyzing could comprise any sequence of operation which could be executed by a computer system with the goal of managing a workflow.

As shown in FIG. 2, a management situation 150, associated to a workflow 250 is a chain of management infons in which all management infons 100 are anchored to the activities 200 that make the workflow 250. FIG. 2 also shows an exemplary relationship between a workflow 250, an activity 200, a management infon 100 and a management situation 150. Therein, it can be seen that a particular workflow instance (“Workflow A”, “Workflow B”, “Workflow C” or “Workflow AB”) has activities 200 (“Activity A1”, “Activity A2”, “Activity A3”, “Activity B1”, “Activity B2”, “Activity B3”, “Activity C1”) associated therewith. When these activities are executed, they result in the generation of corresponding management infons 100 which are associated with the management situation 150 corresponding to the workflow instance. The generation of management infons can be performed by a situation engine, which may also be called a management infon engine 80, as shown in FIG. 8, and which is executed by a processor, e.g. processor 90 of FIG. 2. For example, as also shown in FIG. 2, “Activity B1” generates a corresponding management infon, “infon B1”, “Activity B2” generates a management infon, “infon B2”, etc.

The workflows 250 may spans across multiple domains and technologies within the communications network. This means that the activities executed by the workflows, e.g. “Workflow AB” of FIG. 2, can be executed by nodes 50 of different domains 30 and that these nodes can be from different manufacturers, thus possibly having different communication interfaces and/or protocols.

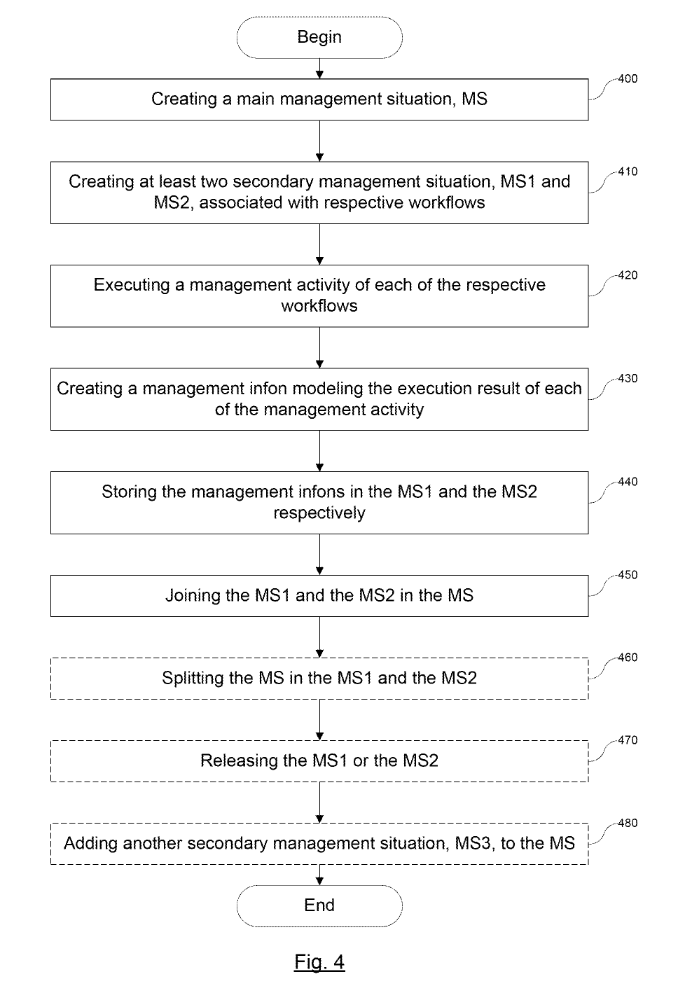

FIG. 4 illustrates an alternative method for workflow management in a communications network. The method comprises the steps of creating 400 a main management situation 150, MS, for containing at least one management infon, creating 410 at least two secondary management situation, MS1 and MS2, being associated with respective workflows, each containing at least one management activity, executing 420 the at least one management activity of each of the respective workflows, creating 430 the management infon modeling an execution result of each of the at least one management activity, storing 440 the management infon in the MS1 and the MS2 respectively and joining 450 the MS1 and the MS2 in the MS.

Once the MS1 and the MS2 have been joined in the MS, it is possible to split 460 them back into the MS1 and the MS2, as explained below. Furthermore, the MS1 or the MS2 can be released 470 or another management situation the MS3 can be added 480 to the MS.

In general, different operations can be performed on management situations. A management situation 150 can be initiated. A secondary management situation can be invited to participate in the management situation, the secondary management situation can accept or refuse to participate in the management situation and the secondary management situation can start participating in the management situation. A secondary management situation can leave the management situation, a management situation can release a secondary management situation and two management situations can be joined in a main management situation. In order to join two management situations, an infon-enabled computer system 50, described below, can create a link between both management situations. After joining two management situations the computer system 50 may regard the both different but joined management situations as one management situation. A split operation can also be preformed on joined management situations to split or unjoin two previously joined management situations and thereby re-establishing the original management situations that existed before the join operation.

Furthermore, when managing e2e services in a large multi-technology or multi-vendor network, it is inevitable to have to involve several workflow systems in different domains 30 of the network. Currently there is little or no interaction between these systems in order to activate an e2e service. The method illustrated in FIG. 4 provides for the management of heterogeneous workflows using the theory of situation semantics.

FIGS. 5 to 7 depict heterogeneous interoperating workflows. In the figures, “Activity A1” to “Activity A3”, “Activity B1” to “Activity B3” and “Activity C1” represent one or several activities 200 within a workflow 250. In order to enable an e2e view of the workflows with regards to states, data and processes, the management infons 100 are created and stored in a common management situation 150, MS.

These figures also illustrate management situations 150 for combined workflows 250 which model e2e management situations 150 which are joints of management situations of composite workflows. Different types of combined workflows exist, such as chained workflows, hierarchical workflows and meshed workflows which will be discussed in more details herein. However, as apparent to a person skilled in the art, the present invention could also apply to other types of workflows 250.

FIG. 5 illustrates a chained workflow which is made of workflows that are executed sequentially and that are interconnected at a certain point, e.g. between “Activity A3” and “Activity B1” of “Workflow A” and “Workflow B” respectively. In this figure, the chained workflow is formed by “Workflow A” and “Workflow B”. The activities in “Workflow A” are first completely executed and then the activities in “Workflow B” are triggered from the interconnection point. The Management Situation 150, MS contains infons 100 generated by the execution of the activities “Activity A1” to “Activity B3”.

FIG. 6 illustrates a hierarchical workflow which is made of workflows having superior/subordinate relationships. As shown in the figure, “Workflow A” is a superior workflow while “Workflow B” and “Workflow C” are subordinate workflows. The ensemble of workflows “Workflow A”, “Workflow B” and “Workflow C” forms the hierarchical workflow. The activities of workflows “Workflow B” and “Workflow C” are executed after these workflows have been initiated by “Workflow A”. Again, the Management Situation 150, MS contains infons 100 generated by the execution of activities “Activity A1” to “Activity C1.”

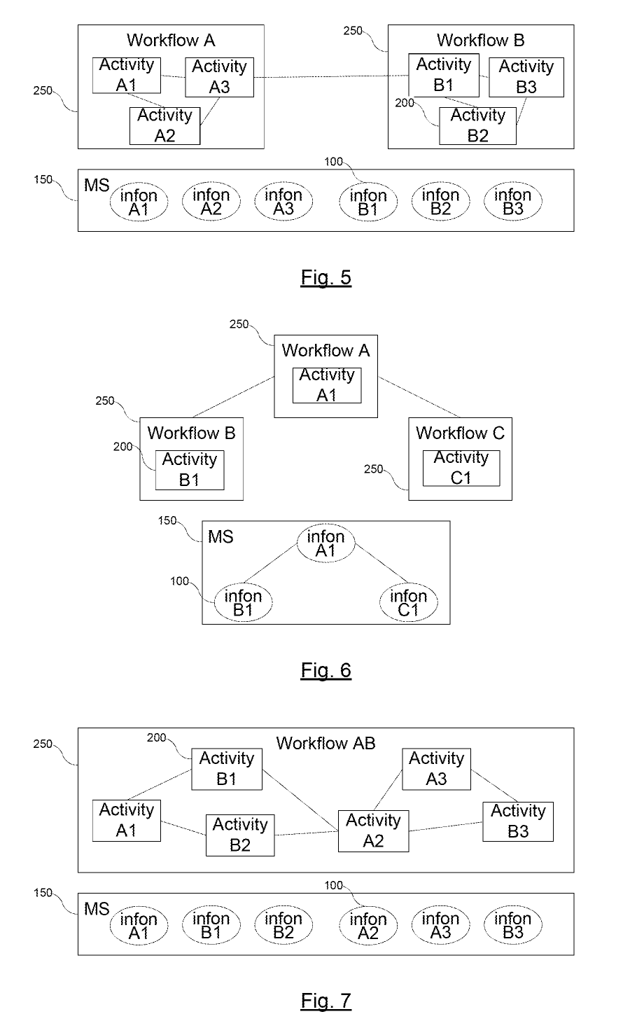

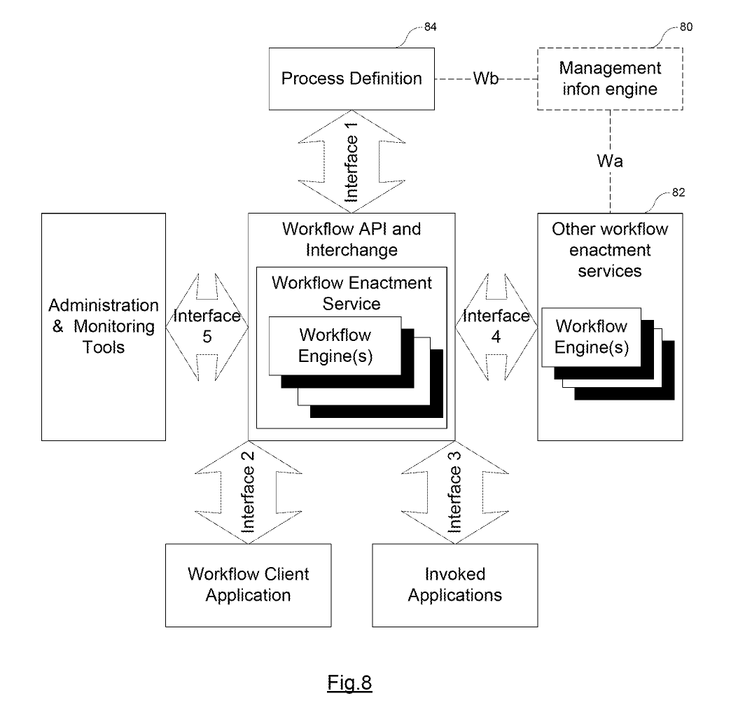

FIG. 7 illustrates a meshed workflow which is made of combined activities from two or more workflows that are seamlessly interconnected. The control of the combined workflow may be handled by either “Workflow A” or “Workflow B”. Again, the Management Situation 150, MS contains infons 100 generated by the execution of the activities “Activity A1” to “Activity B3”.

FIG. 8 illustrates the management situation semantics reference model for workflow management which is an extension of the workflow model. In this figure, Wa is the reference point defining the interface between the management infon engine 80 and the Workflow Enactment Service 82 as defined in David Hollingsworth, Workflow Management Coalition, The workflow Reference Model, TC00-1003, Issue 1.1. Wa refers to the operations on the management infons 100 as well as the operations on the management situations 150. Wb is the reference point defining the interface between the management infon engine 80 and the Process Definition 84 as defined by David Hollingsworth in the above cited reference.

FIG. 8 further shows the impact of the present invention on the Workflow Management Coalition (WfMC) specification. In accordance to the present invention, the workflow model should be updated by adding the management infon engine 80. The specification of the WfMC should also be updated accordingly.

The TeleManagement Forum (TMF) New Generation OSS and Software (NGOSS) initiative provides a comprehensive framework of development which include a business process framework called Enhanced Telecom Operations Map (eTOM) which has been adopted as ITU-T standard under the name M.3050, a systems integration framework called Technology Neutral Architecture (TNA), an information framework called Shared Information and Data Model (SID) and an application framework called Telecom Application MAP (TAM). The NGOSS recommends that all business processes, or workflows, should be managed by process controller externalized from application and policy business rules which can be changed frequently. The management situations 150 described in this invention will be useful for tracking what is happening during the execution of these business processes at the multi-service level.

Some example will now be presented. Example 1 concerns a management infon for a management activity and presents the descriptor “R” or relation component of the management infon. Lets consider a workflow, “Workflow A”, that creates a broadband subscription service made of two activities “Activity A1” and “Activity A2”, the first one being ActivateSubscription and the second one being InstallSTB. The management infon, “infon A1”=<<ActivateSubscription, Admin, User, AAA, BillingServer, Location, Time, yes>>, generated after the execution of the first activity “Activity A1”, states that the managed objects i.e. Admin, User, AAA_BillingServer, Location and Time are related by a relation called ActivateSubscription. Similarly, the management infon, “infon A2”=<<InstallSTB, Technician, Location, Time, yes>>, generated after the execution of the second activity “Activity A2”, states that three managed objects i.e. Technician, Location and Time are related by a relation called InstallSTB.

Example 2 concerns a management situation associated with a workflow. Lets consider the workflow, “Workflow A”, for broadband subscription service creation, from Example 1. In this case, the management situation would be a chain made of infons, “infon A1” and “infon A2”. More specifically, the management system that owns the “Workflow A” would initiate this workflow and the workflow enactment service would generate the management infons in the context of this workflow.

Example 3 concerns operations on management situations. This exemple deals with the case of multiple workflows in a Multi Vendor (MV) management context. Lets consider a workflow with the purpose of increasing the e2e bandwidth, e.g. the bitrate, in a network consisting of equipment from different vendors. As described above, management activities create corresponding management infons when executed. In this example the management activities and the corresponding management infons are related in a hierarchical order, as depicted in FIG. 6, to reflect the fact that the operator initiates the IncreaseBandwidth workflow, “Workflow A” at the Multi Service Resource Manager (MSRM) level, which results in subordinate workflows, “Workflow B” and “Workflow C” and activities in each vendor Operations Support Systems (OSS). This leads to the creation of corresponding management infons for each vendor equipment. In this example, the MSRM initiates a management situation that triggers the “Workflow A”. The “Workflow A” then triggers “Activity A1” and “infon A1” is generated, “infon A1”=<<Increasee2eBandwidth, Admin, OSS_Vendor1, OSS_Vendor2, Location, Time, yes>>. This management infon models the activity of increasing the e2e bandwidth and states that the managed objects, i.e. Admin, Vendor1, Vendor2, Location and Time are related by a relation called Increasee2eBandwidth. To make this example simple we consider that this activity consists of initiating the increase of bandwidth in subordinate workflows. At this point the management situation, MS={“infon A1”}. The MSRM then asks the OSS Vendor1 to participate to the created management situation MS. The “Workflow B” then creates “infon B1”=<<IncreaseBandwidth, Admin, OSS_Vendor1, EdgerouterVendor1, CorerouterVendor1, Location, Time, yes>>. Thereafter, the “Workflow B” invokes the “Leave” operation to leave the MS. The management infon, “infon B1”, models the management activity consisting of increasing the bandwidth in a network made of equipments from Vendor1 and states that the managed objects i.e. Admin, EdgerouterVendor1, CorerouterVendor1, Location and Time are related by a relation called IncreaseBandwidth. To keep this example simple we consider that increasing bandwidth in network Vendor1 triggers a change of the software licenses. At this point the MS={“infon A1”, “infon B1”}. Similarly the MSRM asks the OSS Vendor2 to participate to the created management situation MS. The “Workflow C” creates “infon C1”=<<IncreaseBandwidth, Admin, OSS_Vendor2, EdgerouterVendor2, CorerouterVendor2, Location, Time, yes>>. Thereafter, “Workflow C1” invokes the “Leave” operation and leaves the MS. The management infon, “infon C1”, states that the managed objects i.e. Admin, EdgerouterVendor2, CorerouterVendor2, Location and Time are related by a relation called IncreaseBandwidth. To keep this example simple we consider that increasing bandwidth in network Vendor2 also triggers a change of the software licenses. At the end, the MS={“infon A1”, “infon B1”, “infon C1”}.

Another way to handle the case of Example 3 would be that MSRM asks OSS_Vendor1 and OSS_Vendor2 to create two separate management situations MS1 and MS2 respectively and then the MSRM could join the management situations MS1 and MS2 in MS. MS={“infon A1”, join (MS1, MS2)}={“infon A1”, “infon B1”, “infon C1”}. Similarly the modeling of multiple workflows in the Multi Technology (MT) context can be handled in the same way as in the MV case.

Example 4, with reference to FIG. 2, illustrates how management infons can be used to enable interoperability between heterogeneous workflows to activate an e2e transport service with a certain bandwidth, for example for Video on Demand (VoD). The Multiservice Activator invokes the “Workflow A” in the Activator 1 and the “Workflow B” in the Activator 2. A workflow engine executing in the Multiservice Activator initiates a management situation called MS and asks “Workflow A” to participate in the MS. “Workflow A” generates “infon A1.2”, “infon A1.2”, “infon A2” and “infon A3” corresponding to the activities “Activity A1”, “Activity A2” and “Activity A3”, as described below.

The management infon, “infon A1.1”=<<Sete2eBandwidthVoD10MB, Admin, FirstRouter, OSS1, T1, no>>, for the “Activity A1” has a polarity=no. It means that the management activity “Activity A1” was not executed properly. Accordingly, “Workflow A” tries to allocate less bandwidth, which results in “infon A1.2”=<<Sete2eBandwidthVoD5MB, Admin, FirstRouter, OSS1, T2, yes>>. The polarity=yes indicates that the bandwidth allocation was successful. “Workflow A” then executes the management activities “Activity A2” and “Activity A3” and generates the corresponding management infons “infon A2”=<<Sete2eBandwidthVoD5MB, Admin, SecondRouter, OSS1, T3, yes>> and “infon A3”=<<Sete2eBandwidthVoD5MB, Admin, ThirdRouter, OSS1, T4, yes>>.

The Multiservice Activator then asks the “Workflow B” to participate in the MS, through the infon adaptation layer 112. If the “Workflow B” accepts, it gains access to the management infons already in the MS, through the infon adaptation layer, which include “infon A1.1”, “infon A1.2”, “infon A2” and, “infon A3”. “Workflow B” thus has access to information indicating that the set up of the VoD service with 10 MB bandwidth was not possible but the set up of VoD service with 5 MB was successful. With this information, “Workflow B” can be modified and a management activity for the activation of a 5 MB VoD service can be added. The “Workflow B” then executes the management activities “Activity B1”, “Activity B2” and “Activity B3” and corresponding management infons are generated and added to the MS “infon B1”=<<Sete2eBandwidthVoD5MB, Admin, FourthRouter, OSS2, T5, yes>>, “infon B2”=<<Sete2eBandwidthVoD5MB, Admin, FifthRouter, OSS2, T6, yes>> and “infon B3”=<<Sete2eBandwidthVoD5MB, Admin, SixthRouter, OSS2, T7, yes>>.

The management infons in the MS indicate that “Workflow B” has not set up a path of 10 MB but only of 5 MB since it had gained access to the management infons already in the MS indicating that only 5 MB was allocated previously. Having this information in the MS, if some bandwidth becomes available, an upgrade management activity could be triggered and the system could upgrade this e2e transport service to one VoD service with 10 MB.

Example 5 also concerns a multiservice activator, as in the previous example, except that it uses “Workflow AB”, also shown in FIG. 2. “Workflow AB” calls two subordinate “Workflow A” and “Workflow B”. Every node of the figure is infon-enabled, which means that they have the capability to produce management infons either by way of an infon adaptation layer 112 or by way of proprietary function or hardware.

To activate an e2e transport service with a certain bandwidth, for example for Video on Demand, the “Workflow AB” in the Multiservice Activator invokes the “Workflow A” in the Activator 1 and the “Workflow B” in the Activator 2. The steps of this procedure are described next. First, the “Workflow AB” initiates a management situation called MS. Then, the “Workflow AB” asks the “Workflow A” to participate in the MS. The “Workflow A” accepts to participate in the MS and the “Workflow AB” invokes the “Workflow A” which executes activities “Activity A1”, “Activity A2” and “Activity A3” and generates the corresponding infons, “infon A1.1”=<<Sete2eBandwidthVoD10MB, Admin, Router100, OSS1, T1, no>>, “infon A1.2”=<<Sete2eBandwidthVoD5MB, Admin, Router100, OSS1, T2, yes>>, “infon A2”=<<Sete2eBandwidthVoD5MB, Admin, Router110, OSS1, T3, yes>> and “infon A3”=<<Sete2eBandwidthVoD5MB, Admin, Router120, OSS1, T4, yes>>. These infons now form the management situation MS.

In this example and in the previous example, Activator 2 is a legacy node which needs an infon adaptation layer 112 in order to be able to generate management infons. The infon adaptation layer is used between the management infon engine shown in FIG. 7 and the “Workflow A” which would be represented as component 82 in FIG. 8. Infon-enabled nodes, such as Activator 1 of this example, do not need an infon adaptation layer to generate infons.

The “Workflow AB” then asks the “Workflow B” to participate in the MS through the Infon Adaptation Layer 112. “Workflow B” now has access to the management infons in the MS, through the infon adaptation layer 112, which include “infon A1.1”, “infon A 1.2”, “infon A2” and “infon A3”. As in the previous example, the “Workflow B” can access information in the MS indicating that the set up of the VoD service with a 10 MB bandwidth was not possible but that the set up of a VoD service with 5 MB was successful. With this information, the “Workflow B” can be modified and a management activity for activating the setup of a VoD service with 5 MB in other routers can be added. The “Workflow B” then executes activities “Activity B1”, “Activity B2” and “Activity B3” and generates the following management infons “infon B1”=<<Sete2eBandwidthVoD5MB, Admin, Router200, OSS2, T5, yes>>, “infon B2”=<<Sete2eBandwidthVoD5MB, Admin, Router210, OSS2, T6, yes>> and “infon B3”=<<Sete2eBandwidthVoD5MB, Admin, Router220, OSS2, T7, yes>>. Therefore, this indicates that the “Workflow B” has not set up a path of 10 MB but of only 5 MB. Again, with this information available in the MS, an upgrade activity could be triggered subsequently to upgrade this e2e transport service to 10 MB.

The invention has been described with reference to a particular embodiment. However, it will be readily apparent to those skilled in the art that it is possible to embody the invention in specific forms other than the one of the embodiment described above. The described embodiment is merely illustrative and should not be considered restrictive in any way. The scope of the invention is given by the appended claims, rather than the preceding description, and all variations and equivalents that fall within the range of the claims are intended to be embraced therein.

What is claimed is:

1. A computer readable medium containing a management infon modeling an execution result of a management activity in a communications network, said management infon comprising:
a descriptor of the management activity;
at least one value representing a managed object involved in the management activity; and
an indication of the execution result of the management activity.

2. The computer readable medium of claim 1, wherein the management infon further comprises:
a location value, indicating a location of execution of the management activity; and
a time value, indicating a time of execution of the management activity.

3. The computer readable medium of claim 1, wherein said management infon is a mathematical object containing semantic information.

4. The computer readable medium of claim 1, wherein said descriptor of the management activity is a relation modeling the management activity.

5. The computer readable medium of claim 1, wherein said indication of the execution result of the management activity is a boolean value indicative of a successful execution of the management activity.

6. The computer readable medium of claim 1, wherein the management activity comprises a control process instance.

7. The computer readable medium of claim 1, wherein the management activity comprises a transport services handling process.

8. The computer readable medium of claim 1, wherein the management activity comprises an authentication process.

9. The computer readable medium of claim 1, wherein the management activity comprises an authorization process.

10. The computer readable medium of claim 1, wherein the management activity comprises a subscription activation process.

11. The computer readable medium of claim 1, wherein the management activity comprises an end-to-end (e2e) bandwidth allocation process.

12. A method for workflow management in a communications network, comprising the steps of:
a) executing a management activity defined by at least one workflow;
b) creating a management infon modeling an execution result of the management activity, said management infon comprising:
a descriptor of the management activity;
at least one value representing a managed object involved in the management activity; and
an indication of the execution result of the management activity.

13. The method of claim 12, further comprising the step of managing said at least one workflow using said management infon.

14. The method of claim 12, wherein the management activity comprises more than one management activity and the management infon for comprises more than one management infon.

15. The method of claim 12, further comprising, after step b), the step of storing said management infon in a management situation, MS, associated with the at least one workflow.

16. The method of claim 12, wherein the step of managing comprises the steps of:
i) analyzing said management infon; and
ii) modifying management activities in the at least one workflow according to the step of analyzing.

17. The method of claim 12, wherein said at least one workflow spans multiple domains and technologies within said communications network.

18. A method for workflow management in a communications network, comprising the steps of:
a) creating a main management situation, MS, for containing at least one management infon;
b) creating at least two secondary management situation, MS1 and MS2, being associated with respective workflows, each containing at least one management activity;
c) executing the at least one management activity of each of the respective workflows;
d) creating the management infon modeling an execution result for each of the at least one management activity;
e) storing said management infon in the MS1 and the MS2 respectively; and
f) joining the MS1 and the MS2 in the MS.

19. The method of claim 18, further comprising the step of splitting the MS in the MS1 and the MS2.

20. The method of claim 18, further comprising the step of releasing the MS1 or the MS2.

21. The method of claim 18, further comprising the step of adding an other secondary management situation, MS3, to the MS.

22. The method of claim 18, wherein said workflows span multiple domains and technologies within said communications network.

23. A computer system in a communications network, comprising a processor for executing a function creating a management infon modeling an execution result of a management activity, said management infon comprising:
a descriptor of the management activity;
at least one value representing a managed object involved in the management activity; and
an indication of the execution result of the management activity.

24. The computer system of claim 23, further comprising a memory for storing said management infon.

25. The computer system of claim 24, wherein said memory stores the management infon in a management situation, MS.

26. The computer system of claim 23, further comprising a function for storing the management infon in a memory located in an other node.

27. The computer system of claim 26, wherein said memory located in the other node stores the management infon in a management situation, MS.
